(19) United States
(12) Patent Application Publication
(10) Pub. No.: US 2014/0077644 A1
(43) Pub. Date: Mar. 20, 2014

(54) AC GENERATOR FOR VEHICLES

(71) Applicant: DENSO CORPORATION, Kariya-city (JP)

(72) Inventor: Kazuyoshi ONISHI, Okazaki-shi (JP)

(21) Appl. No.: 14/032,666

(22) Filed: Sep. 20, 2013

(30) Foreign Application Priority Data
Sep. 20, 2012 (JP) 2012-206479

(51) Int. Cl. H02K 5/16

(52) U.S. Cl. CPC H02K 5/161
USPC 310/90

(57) ABSTRACT

An AC generator for vehicles includes a rotor, a stator, a frame, a bearing retaining portion, and a resin-made cylindrical member. The bearing retaining portion is disposed in the frame, and retains a bearing that rotatably supports the rotor. The resin-made cylindrical member is disposed between the bearing and the bearing retaining portion, and an inner circumferential surface thereof has a simple cylindrical shape while an outer circumferential surface thereof has a thick portion in a part thereof.

### CROSS-REFERENCE TO RELATED APPLICATION

This application is based on and claims the benefit of priority from earlier Japanese Patent Application No. 2012-206479 filed Sep. 20, 2012, the description of which is incorporated herein by reference.

### TECHNICAL FIELD

The present disclosure relates to an AC generator for vehicles installed on a truck, an automobile, or the like.

### BACKGROUND

Conventionally, in order to prevent an outer race of a bearing from a creeping, an AC generator for vehicles provided with a cylindrical member (resin case) between the bearing and a bearing retaining portion formed in a housing is known (refer to Technical Disclosure Bulletin No. 2012-503018 published by Japan Institute for Promoting Invention and Innovation, for example).

In this AC generator, a shape of the cylindrical member is not completely cylindrical, but parts of an inner circumferential surface are made flat.

However, most of an outer circumferential surface of the cylindrical member equipped in the AC generator disclosed in the Bulletin mentioned above is in contact with the inner circumferential surface of the bearing retaining portion, and a contact area is large.

Therefore, there is a possibility that a load increases when press-fitting the cylindrical member into the bearing retaining portion, and a problem arises that the cylindrical member may be damaged.

Further, since flat portions formed on the inner circumferential surface of the cylindrical member are in contact locally with an outer circumferential surface of the outer race of the bearing, stress is concentrated at this contact portion.

Therefore, a rolling body orbit of the outer race of the bearing is locally deformed and a movement of the rolling body during rotation becomes unstable, thus a damage of a cage of the rolling body inside the bearing is induced, and there is a problem that life of the bearing is reduced finally.

### SUMMARY

An embodiment provides an AC generator for vehicles that can prevent a damage of a cylindrical member disposed between a bearing and a bearing retaining portion, and can extend life of the bearing by reducing a partial stress concentration that acts on an outer race of the bearing.

In an AC generator for vehicles according to a first aspect, the AC generator includes a rotor that rotates integrally with a pulley which is driven by a belt, a stator disposed facing the rotor, a frame that supports the stator and the rotor, bearing retaining portions, which are disposed in the frame, for retaining a pair of bearings that rotatably support the rotor, and a resin-made cylindrical member of which an inner circumferential surface has a simple cylindrical shape and has a thick portion in a part of an outer circumferential surface thereof.

The cylindrical member is disposed between the bearing and the bearing retaining portion at least in a side opposite to the pulley.

By disposing the thick portion, i.e., a convex shape in the part of the outer circumferential surface of the resin-made cylindrical member, a contact area between the inner circumferential surface and the outer circumferential surface of the bearing retaining portion can be reduced.

Thus, it is possible to prevent the cylindrical member from being damaged by reducing a load when press-fitting the cylindrical member into the bearing retaining portion.

Further, it is possible to equalize a load acting on an entire outer race of the bearing by forming the inner circumferential surface of the cylindrical member into the simple cylindrical shape; lengthening life of the bearing becomes possible.

In the AC generator for vehicles according to a second aspect, wherein, a thickness of the thick portion is greater than a gap formed between the bearing and the bearing retaining portion.

In the AC generator for vehicles according to a third aspect, wherein, the thick portion is disposed at a plurality of locations in a circumferential direction.

In the AC generator for vehicles according to a fourth aspect, wherein, the plurality of the thick portions is disposed at equal intervals in the circumferential direction.

In the AC generator for vehicles according to a fifth aspect, wherein, the resin-made cylindrical member is assembled by being inserted into the bearing retaining portion by press-fitting and an insertion-side outer diameter of the thick portion is smaller than a non-insertion-side outer diameter.

In the AC generator for vehicles according to a sixth aspect, the resin-made cylindrical member is assembled by being inserted into the bearing retaining portion by press-fitting and a bearing-insertion-side inner diameter of the inner circumferential surface of the resin-made cylindrical member is larger than an anti-bearing-insertion-side inner diameter of the resin-made cylindrical member.

In the AC generator for vehicles according to a seventh aspect, the thick portion has a space formed inside thereof.

In the AC generator for vehicles according to an eighth aspect, the space is opened to an external space in the outer circumferential surface of the cylindrical member.

### BRIEF DESCRIPTION OF THE DRAWINGS

In the accompanying drawings:

FIG. 1 shows a cross-sectional view showing the overall structure of an AC generator for the vehicles according to an embodiment;

FIG. 2 shows a perspective view of a resin-made cylindrical member;

FIG. 3 shows a plan view of the cylindrical member;

FIG. 4 shows an enlarged sectional view taken along a line IV-IV of FIG. 3;

FIG. 5 shows an enlarged cross-sectional view of the cylindrical member in a first modification;

FIG. 6 shows an enlarged cross-sectional view of the cylindrical member in a second modification;

FIG. 7 shows a plan view of the cylindrical member in a third modification;

FIG. 8 shows a partial plan view of the cylindrical member in a fourth modification;

FIG. 9 shows a partial plan view of the cylindrical member in a fifth modification;

FIG. 10 shows a plan view of the cylindrical member in a sixth modification; and

FIG. 11 shows a plan view of the cylindrical member in a seventh modification.

### DETAILED DESCRIPTION OF THE PREFERRED EMBODIMENTS

With reference to the drawings, hereinafter will be described an embodiment of an AC generator for the vehicles in which the present disclosure is applied.

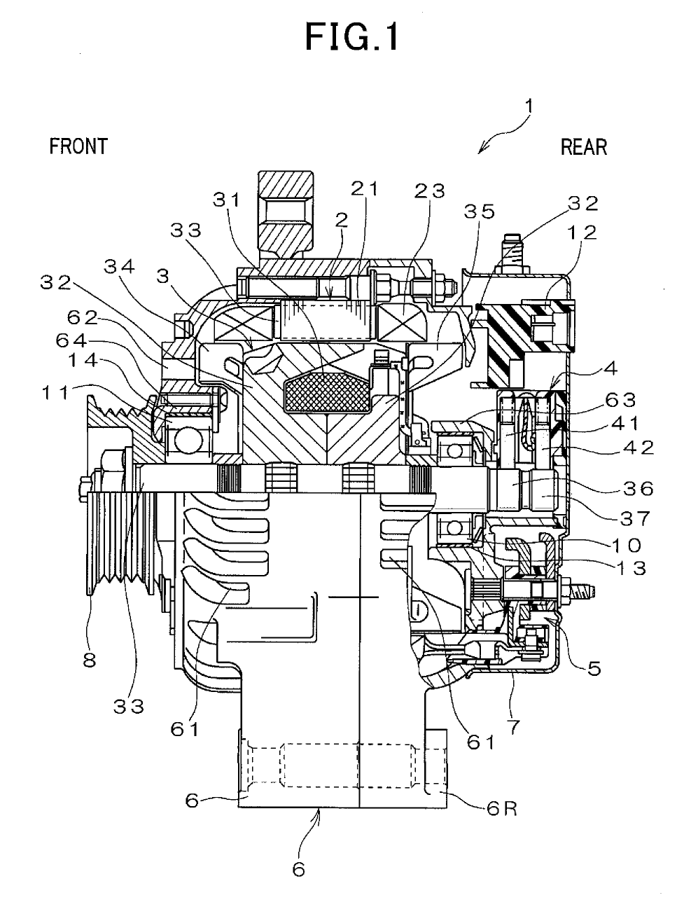

An AC generator for vehicles 1 (hereafter, simply the AC generator) shown in FIG. 1 is configured to include stators 2, a rotor 3, a brush device 4, a rectifier device 5, a frame 6, a rear cover 7, a pulley 8 and the like.

The stators 2 are provided with a stator core 21 and a three-phase stator winding 23 wound around a plurality of slots formed in the stator core 21 at a predetermined interval

The stators 2 are disposed facing the rotor 3.

The rotor 3 has a structure that a field winding 31 formed by winding an insulated copper wire coaxially and cylindrically is sandwiched from both sides through a rotating shaft 33 by pole cores 32F, 32R each having a plurality of magnetic pole claws.

Further, a cooling fan 34 is attached by welding or the like to an end face of the front side (left side in FIG. 1) pole core 32F.

Similarly, another cooling fan 35 is attached by welding or the like to an end face of the rear side (right side in FIG. 1) pole core 32R.

The rotor 3 is rotated integrally with the pulley 8 that is driven by a belt (not shown).

The brush device 4 is intended for applying exciting current to the field winding 31 of the rotor 3 from the rectifier device 5, and has brushes 41 and 42 pressed against respective slip rings 36, 37 formed on the rotating shaft 33 of the rotor 3.

The rectifier 5 converts a three-phase AC voltage, which is an output voltage of the three-phase stator winding 23, into an output voltage of a DC, for example, by rectifying.

The frame 6 supports the rotor 3 and the stators 2. The rotor 3 is rotatably supported around the rotational shaft 33 by a pair of bearings 10 and 11 inside the frame 6. The stators 2 are disposed on outer peripheral sides of the pole cores 32F, 32R of the rotor 3 with a predetermined gap therebetween, and are fixed to the frame 6

Further, discharge openings 61 of the cooling air are formed on the frame 6 in portions that face the stator winding 23 that projects from an axial end surface of the stator core 21, and intake openings 62 of the cooling air are formed on an axial end surface of the frame 6.

The rear cover 7 is provided to cover the brush device 4 mounted outside the rear side frame 6, the rectifier device 5 and an IC regulator 12 entirely to protect these components.

In the AC generator 1 having the structure described above, the rotor 3 rotates in a predetermined direction when a rotating force from an engine (not shown) is transmitted to the pulley 8 through the belt or the like.

By applying an excitation voltage from an outside to the field winding 31 of the rotor 3 in this state, the claw portions of each of the pole cores 32F, 32R are excited, thereby generating a three-phase AC voltage in the stator winding 23, and an output power of the direct current is taken from an output terminal of the rectifier device 5.

Next, details regarding a surrounding structure of the bearings 10 and 11 are explained.

As shown in FIG. 1, the frame 6 is divided in the axial direction into a front frame 6F disposed in the pulley 8 side and a rear frame 6R disposed in a side opposite to the pulley 8. The rear frame 6R has a bearing retaining portion 63 for retaining the bearing 10 therein.

The bearing retaining portion 63 is formed integrally with the rear frame 6R, and assuming that the rear frame 6R is manufacturing by aluminum die casting, the bearing retaining portion 63 is simultaneously formed as a part of the rear frame 6R when manufacturing the rear frame 6R.

In the present embodiment, a resin-made cylindrical member 13 as a resin case is disposed between the bearing 10 and the bearing retaining portion 63.

For example, the bearing 10 is press-fitted into an inner diameter side of the cylindrical member 13 and becomes integrated, and then a whole of the integrated cylindrical member 13 and the bearing 10 are press-fitted into the bearing retaining portion 63.

In addition, the cylindrical member 13 may be press-fitted into the bearing retaining portion 63 first, and then the bearing 10 may be press-fitted into the inner diameter side of the cylindrical member 13.

The method of assembling these components is the same for the bearing 11 which will be described later.

By placing the cylindrical member 13 between an outer race of the bearing 10 formed of a primarily iron-based material and the bearing retaining portion 63 formed of aluminum material, a creeping of the bearing 10 caused by a difference in thermal expansion coefficients thereof can be prevented.

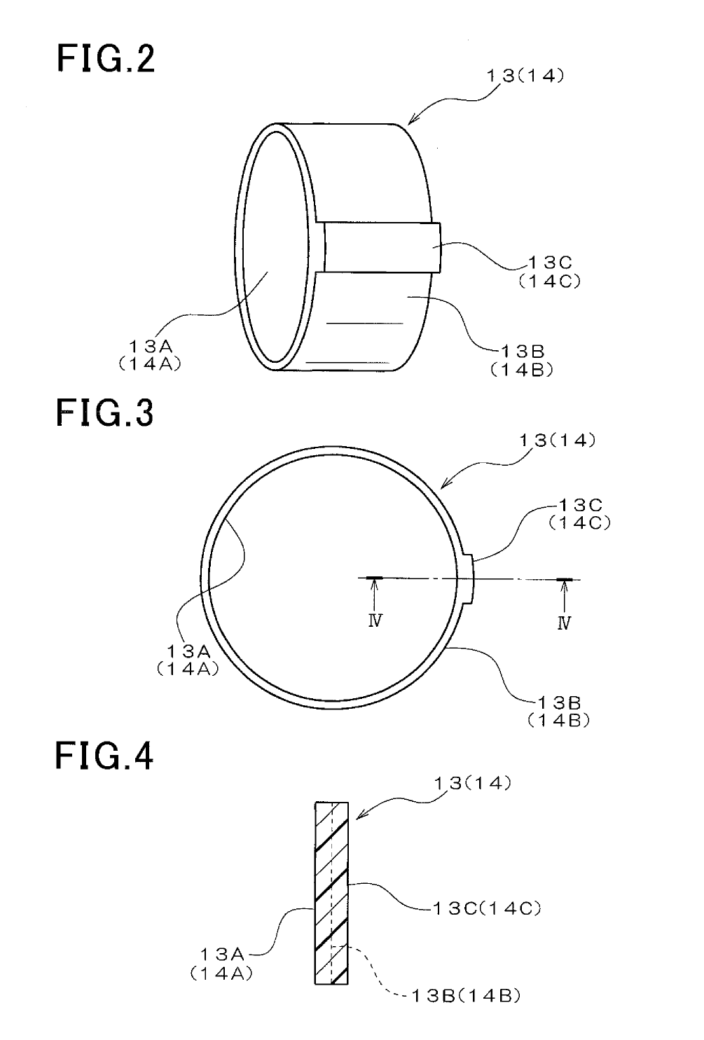

As shown in FIGS. 2 and 3, an inner circumferential surface 13A of the cylindrical member 13 has a simple cylindrical shape, and has a thick portion 13C in a part of an outer circumferential surface 13B of the cylindrical member 13.

The outer circumferential surface 13B except the thick portion 13C has a simple cylindrical shape, and the thick portion 13C is formed by making the part of the outer circumferential surface 13B into a convex shape as to protrude outward in a radial direction.

A thickness of the thick portion 13C is greater than a gap formed between the bearing 10 and the bearing retaining portion 63 that occurs when the cylindrical member 13 is placed in the bearing retaining portion 63.

That is, a predetermined thickness of the thick portion 13C is configured so that the thick portion 13C has a fastening margin with respect to the bearing retaining portion 63 when the cylindrical member 13 is disposed in the bearing retaining portion 63.

Note that regarding the outer circumferential surface 13B other than the thick portion 13C, both cases of imparting and not imparting the tightening margin with respect to the bearing retaining portion 63 can be considered.

Similarly, the front frame 6F has a bearing retaining portion 64 for retaining the bearing 11 therein.

The bearing retaining portion 64 is formed integrally with the rear frame 6F, and assuming that the rear frame 6R is manufacturing by aluminum die casting, the bearing retaining portion 6F is simultaneously formed as a part of the rear frame 6R when manufacturing the rear frame 6R.

A resin-made cylindrical member 14 is disposed between the bearing 11 and the bearing retaining portion 64.

An inner circumferential surface 14A of the cylindrical member 14 has a simple cylindrical shape, and has a thick portion 14C in a part of an outer circumferential surface 14B of the cylindrical member 14.

The outer circumferential surface 14B except the thick portion 14C has a simple cylindrical shape, and the thick portion 14C is formed by making the part of the outer circumferential surface 14B into a convex shape as to protrude outward in a radial direction.

A thickness of the thick portion 14C is greater than a gap formed between the bearing 11 and the bearing retaining portion 64 that occurs when the cylindrical member 14 is placed in the bearing retaining portion 64.

That is, a predetermined thickness of the thick portion 14C is configured so that the thick portion 14C has a fastening margin with respect to the bearing retaining portion 64 when the cylindrical member 14 is disposed in the bearing retaining portion 64.

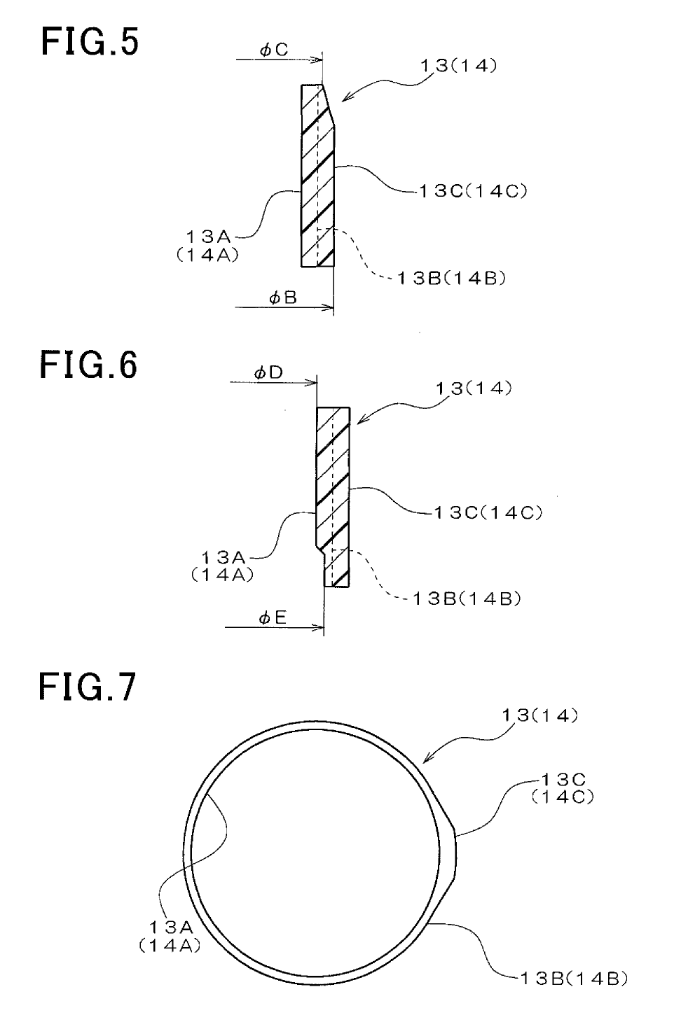

By the way, in addition to a case where a predetermined thickness of the thick portion 13C for an entire region along the axial direction of the cylindrical member 13a is constant as shown in FIG. 4, an insertion-side outer diameter φC of the thick portions 13C may be smaller than a non-insertion-side outer diameter φB, as shown in FIG. 5.

Thereby, since it is possible to increase load acting on the outer circumferential surface 13B of the cylindrical member 13 through the thick portion 13C gradually with a progress of an insertion when inserting the cylindrical member 13 into the bearing retaining portion 63, it is possible to reliably prevent damage to the cylindrical member 13 during assembling.

The same is true for the cylindrical member 14.

In addition, although the entire inner circumferential surface 13A of the cylindrical member 13 is configured to have the same internal diameter as shown in FIG. 4, a bearing-insertion-side inner diameter φE of the inner circumferential surface 13A (larger than an outer diameter φA of the outer race of the bearing 10) may be larger than an anti-bearing-insertion-side inner diameter φD (smaller than the outer diameter φA of the outer race of the bearing 10) as shown in FIG. 6.

When the outer diameter of the outer race of the bearing 10 is φA, a relation of φE>φA>φD is given.

Thus, a positioning of the bearing 10 when inserting into the cylindrical member 13 becomes easy.

The same is true for the cylindrical member 14.

Thus, in the AC generator 1 according to the present embodiment, it is possible to reduce contact areas between the outer circumferential surfaces 13B, 14B and the inner circumferential surfaces of the bearing retaining portions 63, 64 by providing the thick portions 13C, 14C on the parts of the outer circumferential surface 13B, 14B of the cylindrical members 13, 14.

Thereby, it is possible to prevent the cylindrical members 13, 14 from being damaged by reducing the load when press-fitting the cylindrical members 13, 14 into the bearing retaining portions 63, 64.

Further, it is possible to equalize the load acting on the entire outer races of the bearings 10, 11 by forming the inner circumferential surfaces 13A, 14A of the cylindrical members 13, 14 into the simple cylindrical shapes; lengthening life of the bearings 10, 11 becomes possible.

Furthermore, the thicknesses of the thicker portions 13C, 14C are greater than the gaps formed between the bearing retaining portions 64, 64 and the bearings 10, 11.

As a result, it is possible to assemble the AC generator 1 in a state where the cylindrical members 13, 14 are sandwiched reliably between the bearings 10, 11 and the bearing retaining portion 63, 64.

Moreover, it is possible to reliably prevent the outer races of the bearing 10, 11 from creeping within the bearing retaining portions 63, 64.

The present disclosure is not limited to the above embodiment; however, various modifications are possible within the scope of the present disclosure.

For example, although a step is formed at a boundary portion between the outer circumferential surface 13B adjacent to the thick portion 13C in the above embodiment, the boundary portion may be tapered to vary the outer diameter gradually, as shown in FIG. 7, so that there is no step.

The same is true for the thick portion 14C.

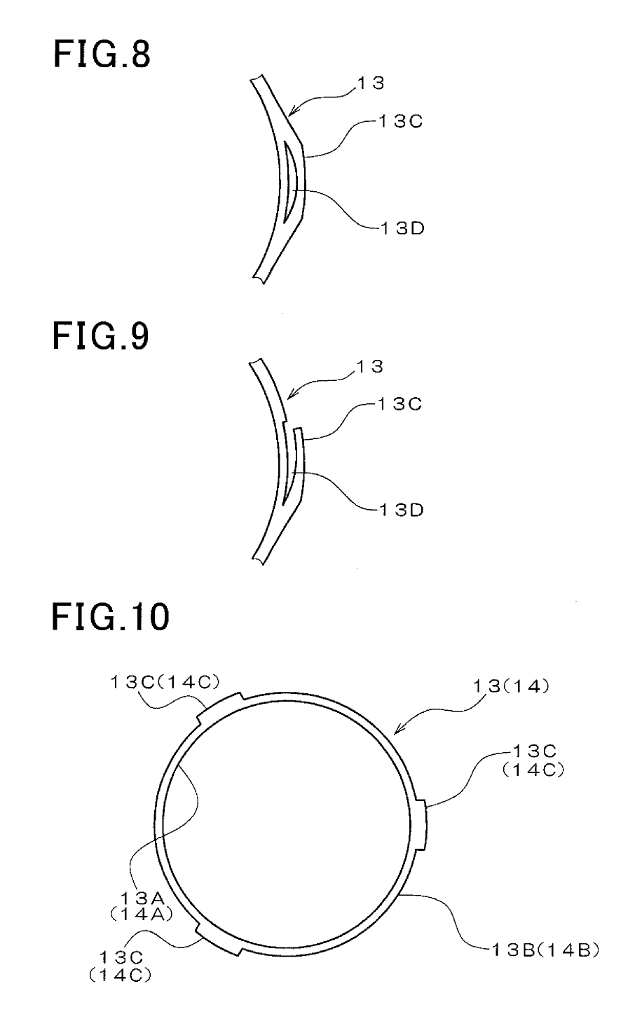

Further, although the thick portion 13C has s solid structure in the embodiment described above, a space (a gap) 13D may be formed inside the thick portion 13 as shown in FIG. 8.

In addition, the space may be opened so as to communicate with an external space in the outer circumferential surface 13B of the cylindrical member 13 as shown in FIG. 9.

By adopting the structure of the thick portion 13C shown in FIG. 9 or FIG. 8, it is possible to further prevent the cylindrical member 13 from being damaged by further reducing the load when press-fitting the cylindrical member 13 into the bearing retaining portion 63.

The same is true for the thick portion 14C.

Furthermore, although the space 13D is formed inside the thick portion 13C shown in FIG. 7 in FIG. 9 and FIG. 8, it is also possible to form the space 13D inside the thick portion 13C having a shape shown in FIG. 3.

Further, although the cylindrical member 13 is disposed between the bearing 10 and the bearing retaining portion 63, and the cylindrical member 14 is disposed between the bearing 11 and the bearing retaining portion 64, only the cylindrical member 13 may be disposed.

This is because since the cylindrical member 14 is disposed close to the pulley 8 in which a belt tension is applied, a radial load applied to the bearing 11 is large, and thus, the outer race of the bearing 11 is less likely to creep.

In this case, the outer race of the bearing 11 may be press-fitted directly into the bearing retaining portion 64.

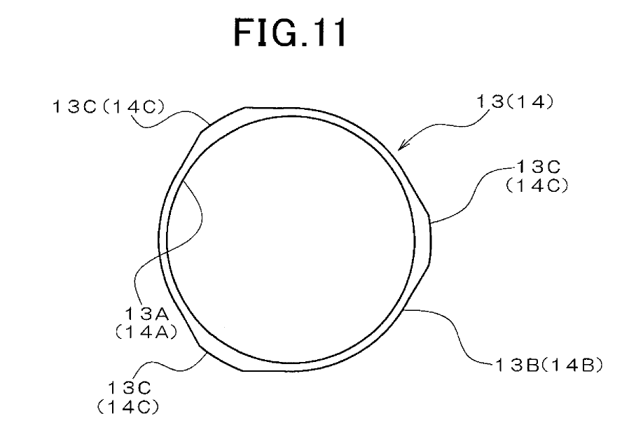

Further, the thick portions 13C may be disposed at a plurality of locations in the circumferential direction as shown in FIG. 10 and FIG. 11.

In this case, the plurality of the thick portions 13C is preferred to be disposed at equal intervals in the circumferential direction.

By disposing the thick portions 13C at a plurality of locations, a deviation of a center axis of rotation can be prevented when assembling the bearing 10 to the bearing retaining portion 63, and thus, the bearing 10 may be assembled with high accuracy, which contributes to improve life of the bearing 10.

The same is true for the thick portion 14C.

According to the present disclosure as mentioned above, by disposing the thick portion in the part of the outer circumferential surface of the cylindrical member, the contact area between the inner circumferential surface and the outer circumferential surface of the bearing retaining portion can be reduced, and thus, it is possible to prevent the cylindrical member from being damaged by reducing the load when press-fitting the cylindrical member into the bearing retaining portion.

What is claimed is:

1. An AC generator for vehicles comprising:
a rotor that rotates integrally with a pulley which is driven by a belt;
a stator disposed facing the rotor;
a frame that supports the stator and the rotor;
bearing retaining portions, which are disposed in the frame, for retaining a pair of bearings that rotatably support the rotor; and
a resin-made cylindrical member of which an inner circumferential surface has a simple cylindrical shape and has a thick portion in a part of an outer circumferential surface thereof; wherein,
the cylindrical member is disposed between the bearing and the bearing retaining portion at least in a side opposite to the pulley.

2. The AC generator for vehicles according to claim 1, wherein,
a thickness of the thick portion is greater than a gap formed between the bearing and the bearing retaining portion.

3. The AC generator for vehicles according to claim 1, wherein,
the thick portion is disposed at a plurality of locations in a circumferential direction.

4. The AC generator for vehicles according to claim 3, wherein,
the plurality of the thick portions is disposed at equal intervals in the circumferential direction.

5. The AC generator for vehicles according to claim 1, wherein
the resin-made cylindrical member is assembled by being inserted into the bearing retaining portion by press-fitting and an insertion-side outer diameter of the thick portion is smaller than a non-insertion-side outer diameter.

6. The AC generator for vehicles according to claim 1, wherein,
the resin-made cylindrical member is assembled by being inserted into the bearing retaining portion by press-fitting and a bearing-insertion-side inner diameter of the inner circumferential surface of the resin-made cylindrical member is larger than an anti-bearing-insertion-side inner diameter of the resin-made cylindrical member.

7. The AC generator for vehicles according to claim 1, wherein,
the thick portion has a space formed inside thereof.

8. The AC generator for vehicles according to claim 7, wherein,
the space is opened to an external space in the outer circumferential surface of the cylindrical member.
